(19) United States
(12) Patent Application Publication
(10) Pub. No.: US 2026/0066459 A1
(43) Pub. Date: Mar. 5, 2026

(54) MICROPOROUS MEMBRANES, SEPARATOR MEMBRANES, BASE FILMS, AND USES THEREOF

(71) Applicant: CELGARD, LLC, Charlotte, NC (US)

(72) Inventors: Yue Ma, Charlotte, NC (US); Changqing Wang Adams, Fort Mill, SC (US); William J. Mason, McConnells, SC (US)

(21) Appl. No.: 19/319,152

(22) Filed: Sep. 4, 2025

Related U.S. Application Data
(60) Provisional application No. 63/690,654, filed on Sep. 4, 2024.

(51) Int. Cl. H01M 50/417; B01D 69/12; B01D 71/26; H01M 50/449

(52) U.S. Cl. CPC H01M 50/417; B01D 69/12; B01D 71/262; H01M 50/449; B01D 2325/04

(57) ABSTRACT

An improved microporous membrane is described herein. The microporous membrane may be useful as a battery separator, separator membrane, base film, or membrane with a variety of uses thereof. The improved microporous membranes described herein may be dry process polyolefin membranes and may be used as battery separators or as a component of a composite or battery separator. The battery separators or composites may be used in energy storage devices including primary batteries, secondary batteries, fuel cells, capacitors, or super capacitors.

### REFERENCE TO RELATED APPLICATIONS

This application claims the benefit of U.S. provisional patent application Ser. No. 63/690,654 filed Sep. 4, 2024, which is fully incorporated by reference herein.

### FIELD

This application is directed to improved microporous membranes, separator membranes, base films, and to a variety of uses thereof. The improved microporous membranes described herein may be dry process polyolefin membranes and may be used as battery separators or as a component of a composite or battery separator. The battery separators or composites may be used in energy storage devices including primary batteries, secondary batteries, fuel cells, capacitors, or super capacitors.

### BACKGROUND

Not every microporous membrane is suitable for use as a battery separator. Basic requirements for a battery separator include, at least, the following: (1) electronically insulating and (2) ionically conductive, e.g., ability to allow for the flow of ions such as Nat, Lit, etc. across the membrane. Regarding (2), wettability of the membrane with the electrolyte to be used in a particular battery is typically a requirement. Additionally, it is preferable that the pores of a microporous membrane being used as a separator are not through-holes. Battery separator manufacturers would typically consider through-holes to be a defect.

Beyond the basics, there are many battery separator properties that are desirable. First, a thin separator (e.g., less than 25 microns) is preferred. Recent market trends prefer a separator that is less than 12 microns. Thinner separators allow battery makers to achieve higher energy density. While it is possible to make separators this thin, they often have issues with one or more of the following: lower puncture strength, high variation in thickness/low thickness uniformity, runnability in modern separator or battery equipment, etc.

Thus, a desire for improved membranes or battery separators that are thin, but are fit for modern batteries and equipment are desirable.

### SUMMARY

In one aspect, an improved membrane is described herein. The membrane has a thickness from 1 microns to 50 microns, 2 microns to 25 microns, 4 microns to 12 microns, or 5 microns to 10 microns and exhibits one or more, two or more, three or more, four or more, five or more, or all of the following properties: (1) a puncture strength of 230 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 10% by weight long chain branched polypropylene; (9) a reduced surface area; and/or (10) a thickness of less than 12 microns.

In another aspect, object or embodiment, a battery separator for use in energy storage devices such as primary batteries, secondary batteries, or fuel cells is described herein. The battery separator may comprise at least one microporous membrane. The microporous membrane may be a microporous membrane, separator membrane, battery separator, or base film comprising a microporous membrane, wherein the microporous membrane has a thickness from 1 microns to 50 microns, 2 microns to 25 microns, 4 microns to 12 microns, or 5 microns to 10 microns, and exhibits one or more, two or more, three or more, four or more, five or more, or all of the following properties: (1) a puncture strength of 230 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 10% by weight long chain branched polypropylene; (9) a reduced surface area; and/or (10) a thickness of less than 12 microns.

The microporous membrane, separator membrane, battery separator, or base film above, wherein the microporous membrane has an MD tensile strength above 2,300 kg/cm², above 2,320 kg/cm², or above 2,340 kg/cm².

The microporous membrane, separator membrane, battery separator, or base film above, wherein the microporous membrane has a porosity above 40% or above 45%.

The microporous membrane, separator membrane, battery separator, or base film above, wherein the microporous membrane is a dry process polyolefin membrane and has a thickness from 5 microns to 10 microns; a puncture strength of 230 gf or more; an MD tensile strength above 2,200 kg/cm²; an increased surface roughness; an average pore size of at least 0.40 microns; an increased DB; a TD tensile strength above 130 kg/cm²; a lower ply to ply adhesion force; a polypropylene blend including up to 5% by weight long chain branched polypropylene; a reduced surface area; and/or a porosity at or above 45%.

The microporous membrane, separator membrane, battery separator, or base film above, wherein the microporous membrane has one or more layers or plies.

The microporous membrane, separator membrane, battery separator, or base film above, wherein the microporous membrane has at least one outer surface, layer or ply made of a polypropylene blend including up to 5% by weight long chain branched polypropylene.

The microporous membrane, separator membrane, battery separator, or base film above, wherein the microporous membrane is a dry-process microporous membrane.

The microporous membrane, separator membrane, battery separator, or base film above, wherein the microporous membrane has a melt point above 165° C.

The microporous membrane, separator membrane, battery separator, or base film above, wherein the microporous membrane is coated on one or two sides thereof.

An energy storage device comprising the microporous membrane, separator membrane, battery separator, or base film above, wherein the energy storage device is a primary battery, a secondary battery, or a fuel cell.

In yet another aspect, object or embodiment, a dry process polyolefin microporous membrane has a thickness from 4 microns to 12 microns, and exhibits one or more of the properties: (1) a puncture strength of 230 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 10% by weight long chain branched polypropylene; (9) a reduced surface area; and/or (10) a porosity of at least 45%.

In still yet another aspect, object or embodiment, a dry process polypropylene microporous membrane has a thickness from 4 microns to 12 microns, and exhibits one or more of the properties: (1) a puncture strength of 230 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 10% by weight long chain branched polypropylene; (9) a reduced surface area; and/or (10) a porosity of at least 45%.

An improved microporous membrane is described herein. The microporous membrane may be useful as a battery separator, separator membrane, base film, or membrane with a variety of uses thereof. The improved microporous membranes described herein may be dry process polyolefin membranes and may be used as battery separators or as a component of a composite or battery separator. The battery separators or composites may be used in energy storage devices including primary batteries, secondary batteries, fuel cells, capacitors, or super capacitors.

In some embodiments, the puncture strength of the microporous membrane may be 230 gf or more, 240 gf or more, 250 gf or more, 260 gf or more, 270 gf or more, or 290 gf or more.

In some embodiments, the microporous membrane may have an MD tensile strength above 2,000 kg/cm², above 2,100 kg/cm², above 2,200 kg/cm², above 2,300 kg/cm², or above 2,340 kg/cm².

In some embodiments, the microporous membrane is a dry-process microporous membrane.

In some embodiments, the microporous membrane is a microporous membrane having a melting point above 165° C.

In some embodiments, the microporous membrane is coated on one or two sides thereof.

In another aspect, an energy storage device comprising the battery separator described herein is described. The energy storage device may be a primary battery, a secondary battery, a fuel cell, a capacitor, or a super capacitor.

In one aspect, an improved membrane is described herein. The membrane has a thickness from 1 microns to 50 microns, 2 microns to 25 microns, 4 microns to 12 microns, or 5 microns to 10 microns and exhibits one or more, two or more, three or more, four or more, five or more, or all of the following properties: (1) a puncture strength of 130 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 50% by weight long chain branched polypropylene; (9) a reduced surface area; and/or (10) a thickness of less than 12 microns.

In another aspect, object or embodiment, a battery separator for use in energy storage devices such as primary batteries, secondary batteries, or fuel cells is described herein. The battery separator may comprise at least one microporous membrane. The microporous membrane may be a microporous membrane, separator membrane, battery separator, or base film comprising a microporous membrane, wherein the microporous membrane has a thickness from 1 microns to 50 microns, 2 microns to 25 microns, 4 microns to 12 microns, or 5 microns to 10 microns, and exhibits one or more, two or more, three or more, four or more, five or more, or all of the following properties: (1) a puncture strength of 130 gf or more; (2) an MD tensile strength above 1,000 kg/cm²; (3) an increased surface roughness; (4) an average pore size of at least 0.20 microns; (5) an increased DB; (6) a TD tensile strength above 50 kg/cm²; (7) a lower ply to ply adhesion force; (8) a polypropylene blend including up to 50% by weight long chain branched polypropylene; (9) a reduced surface area; and/or (10) a thickness of less than 12 microns.

The microporous membrane, separator membrane, battery separator, or base film above, wherein the microporous membrane has an MD tensile strength above 500 kg/cm², above 1,000 kg/cm², or above 2,000 kg/cm².

The microporous membrane, separator membrane, battery separator, or base film above, wherein the microporous membrane has a porosity above 30% or above 40%.

The microporous membrane, separator membrane, battery separator, or base film above, wherein the microporous membrane is a dry process polyolefin membrane and has a thickness from 3 microns to 10 microns; a puncture strength of 130 gf or more; an MD tensile strength above 1,000 kg/cm²; an increased surface roughness; an average pore size of at least 0.20 microns; an increased DB; a TD tensile strength above 50 kg/cm²; a lower ply to ply adhesion force; a polypropylene blend including up to 50% by weight long chain branched polypropylene; a reduced surface area; and/or a porosity at or above 25%.

The microporous membrane, separator membrane, battery separator, or base film above, wherein the microporous membrane has one or more layers or plies.

The microporous membrane, separator membrane, battery separator, or base film above, wherein the microporous membrane has at least one outer surface, layer or ply made of a polypropylene blend including up to 50% by weight long chain branched polypropylene.

The microporous membrane, separator membrane, battery separator, or base film above, wherein the microporous membrane is a dry-process microporous membrane.

The microporous membrane, separator membrane, battery separator, or base film above, wherein the microporous membrane has a melt point above 160° C.

The microporous membrane, separator membrane, battery separator, or base film above, wherein the microporous membrane is coated on one or two sides thereof.

An energy storage device comprising the microporous membrane, separator membrane, battery separator, or base film above, wherein the energy storage device is a primary battery, a secondary battery, or a fuel cell.

In yet another aspect, object or embodiment, a dry process polyolefin microporous membrane has a thickness from 3 microns to 30 microns, and exhibits one or more of the properties: (1) a puncture strength of 130 gf or more; (2) an MD tensile strength above 1,000 kg/cm²; (3) an increased surface roughness; (4) an average pore size of at least 0.20 microns; (5) an increased DB; (6) a TD tensile strength above 50 kg/cm²; (7) a lower ply to ply adhesion force; (8) a polypropylene blend including up to 50% by weight long chain branched polypropylene; (9) a reduced surface area; and/or (10) a porosity of at least 25%.

In still yet another aspect, object or embodiment, a dry process polypropylene microporous membrane has a thickness from 4 microns to 12 microns, and exhibits one or more of the properties: (1) a puncture strength of 130 gf or more; (2) an MD tensile strength above 1,000 kg/cm²; (3) an increased surface roughness; (4) an average pore size of at least 0.20 microns; (5) an increased DB; (6) a TD tensile strength above 50 kg/cm²; (7) a lower ply to ply adhesion force; (8) a polypropylene blend including up to 50% by weight long chain branched polypropylene; (9) a reduced surface area; and/or (10) a porosity of at least 25%.

An improved microporous membrane is described herein. The microporous membrane may be useful as a battery separator, separator membrane, base film, or membrane with a variety of uses thereof. The improved microporous membranes described herein may be dry process polyolefin membranes and may be used as battery separators or as a component of a composite or battery separator. The battery separators or composites may be used in energy storage devices including primary batteries, secondary batteries, fuel cells, capacitors, or super capacitors.

In some embodiments, the puncture strength of the microporous membrane may be 130 gf or more, 140 gf or more, 150 gf or more, 160 gf or more, 170 gf or more, or 190 gf or more.

In some embodiments, the microporous membrane may have an MD tensile strength above 1,000 kg/cm², above 1,100 kg/cm², above 1,200 kg/cm², above 1,300 kg/cm², or above 1,340 kg/cm².

In some embodiments, the microporous membrane is a dry-process microporous membrane.

In some embodiments, the microporous membrane is a microporous membrane having a melting point above 160° C.

In some embodiments, the microporous membrane is coated on one or two sides thereof.

In another aspect, an energy storage device comprising the battery separator described herein is described. The energy storage device may be a primary battery, a secondary battery, a fuel cell, a capacitor, or a super capacitor.

### DESCRIPTION OF DRAWINGS

FIG. 1A and FIG. 1B are each Optical Microscope (or Microscopy) images of the surface of a typical dry-process MD stretched PP microporous membrane.

FIG. 2A and FIG. 2B are each Optical Microscope images of the surface of a dry-process stretched microporous membranes according to some LCB-PP blend embodiments described herein.

FIG. 3A and FIG. 3B are each SEM images and SEM images respectively of the surface of a typical dry-process MD stretched PP microporous membrane.

FIG. 4A and FIG. 4B are each SEM images of the surface of a dry-process stretched microporous membranes according to some LCB-PP blend embodiments described herein

FIG. 5 is a graph of comparison membrane adhesion data.

FIG. 6 is a table of comparative membrane property data.

FIG. 7 shows respective Melt Temperature DSC curves of PP Control and 2% LCB-PP/PP samples.

FIG. 8 shows respective Crystallization Temperature DSC curves of PP Control and 2% LCB-PP/PP samples.

FIG. 9 is a graph of comparison membrane Ply to Ply adhesion test results.

FIG. 10 shows respective Pore Size Distribution curves of PP Control and 2% LCB-PP/PP samples.

FIG. 11 is a graph of comparison membrane DB uniformity data of PP Control and 2% LCB-PP/PP samples.

FIG. 12 is a table of comparative membrane sample Test Data for 100% linear PP and 2% LCB-PP/PP.

### DETAILED DESCRIPTION

An improved microporous membrane is described herein. The improved microporous membrane may be used as a battery separator or as a component of a battery separator. For example, when a battery separator comprises two or membranes, the improved membrane described herein may be at least one of those membranes. The battery separator comprising the improved microporous membranes may be useful in an energy storage device such as a primary battery, a secondary battery, a fuel cell, a capacitor, or a super capacitor. The membrane is described in further detail herein.

### Microporous Membrane

The microporous membranes described herein may have a thickness from 1 microns to 50 microns, from 2 microns to 25 microns, from 4 microns to 12 microns, from 5 microns to 10 microns, from 2 microns to 12 microns, from 2 microns to 11 microns, from 2 microns to 10 microns, from 2 microns to 9 microns, from 2 microns to 8 microns, from 2 microns to 7 microns, from 2 microns to 6 microns, from 2 microns to 5 microns, from 2 microns to 4 microns, or from 2 microns to 13 microns.

The microporous membrane may exhibit one or more, two or more, three or more, four or more, five or more, or all of the following properties: (1) a puncture strength of 230 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 10% by weight long chain branched polypropylene; (9) a reduced surface area; and/or (10) a thickness of less than 12 microns.

In another aspect, object or embodiment, a battery separator for use in energy storage devices such as primary batteries, secondary batteries, or fuel cells is described herein. The battery separator may comprise at least one microporous membrane. The microporous membrane may be a microporous membrane, separator membrane, battery separator, or base film comprising a microporous membrane, wherein the microporous membrane has a thickness from 1 microns to 50 microns, 2 microns to 25 microns, 4 microns to 12 microns, or 5 microns to 10 microns, and exhibits one or more, two or more, three or more, four or more, five or more, or all of the following properties: (1) a puncture strength of 230 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 10% by weight long chain branched polypropylene; (9) a reduced surface area; and/or (10) a thickness of less than 12 microns.

The microporous membrane, separator membrane, battery separator, or base film above, wherein the microporous membrane has an MD tensile strength above 2,300 kg/cm², above 2,320 kg/cm², or above 2,340 kg/cm².

The microporous membrane, separator membrane, battery separator, or base film above, wherein the microporous membrane has a porosity above 40% or above 45%.

The microporous membrane, separator membrane, battery separator, or base film above, wherein the microporous membrane is a dry process polyolefin membrane and has a thickness from 5 microns to 10 microns; a puncture strength of 230 gf or more; an MD tensile strength above 2,200 kg/cm²; an increased surface roughness; an average pore size of at least 0.40 microns; an increased DB; a TD tensile strength above 130 kg/cm²; a lower ply to ply adhesion force; a polypropylene blend including up to 5% by weight long chain branched polypropylene; a reduced surface area; and/or a porosity at or above 45%.

The microporous membrane, separator membrane, battery separator, or base film above, wherein the microporous membrane has one or more layers or plies.

The microporous membrane, separator membrane, battery separator, or base film above, wherein the microporous membrane has at least one outer surface, layer or ply made of a polypropylene blend including up to 5% by weight long chain branched polypropylene.

The microporous membrane, separator membrane, battery separator, or base film above, wherein the microporous membrane is a dry-process microporous membrane.

The microporous membrane, separator membrane, battery separator, or base film above, wherein the microporous membrane has a melt point above 165° C.

The microporous membrane, separator membrane, battery separator, or base film above, wherein the microporous membrane is coated on one or two sides thereof.

An energy storage device comprising the microporous membrane, separator membrane, battery separator, or base film above, wherein the energy storage device is a primary battery, a secondary battery, or a fuel cell.

In yet another aspect, object or embodiment, a dry process polyolefin microporous membrane has a thickness from 4 microns to 12 microns, and exhibits one or more of the properties: (1) a puncture strength of 230 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 10% by weight long chain branched polypropylene; (9) a reduced surface area; and/or (10) a porosity of at least 45%.

In still yet another aspect, object or embodiment, a dry process polypropylene microporous membrane has a thickness from 4 microns to 12 microns, and exhibits one or more of the properties: (1) a puncture strength of 230 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 10% by weight long chain branched polypropylene; (9) a reduced surface area; and/or (10) a porosity of at least 45%.

An improved microporous membrane is described herein. The microporous membrane may be useful as a battery separator, separator membrane, base film, or membrane with a variety of uses thereof. The improved microporous membranes described herein may be dry process polyolefin membranes and may be used as battery separators or as a component of a composite or battery separator. The battery separators or composites may be used in energy storage devices including primary batteries, secondary batteries, fuel cells, capacitors, or super capacitors.

In some embodiments, the puncture strength of the microporous membrane may be 230 gf or more, 240 gf or more, 250 gf or more, 260 gf or more, 270 gf or more, or 290 gf or more.

In some embodiments, the microporous membrane may have an MD tensile strength above 2,000 kg/cm², above 2,100 kg/cm², above 2,200 kg/cm², above 2,300 kg/cm², or above 2,340 kg/cm².

In some embodiments, the microporous membrane is a dry-process microporous membrane.

In some embodiments, the microporous membrane is a microporous membrane having a melting point above 165° C.

In some embodiments, the microporous membrane is coated on one or two sides thereof.

In another aspect, an energy storage device comprising the battery separator is described herein. The energy storage device may be a primary battery, a secondary battery, a fuel cell, a capacitor, or a super capacitor.

In preferred embodiments, the microporous membrane exhibits a puncture strength of 230 gf or more.

In preferred embodiments, the microporous membrane exhibits a MD tensile strength above 2,290 kg/cm².

In preferred embodiments, the microporous membrane exhibits a porosity of at least 40%.

In some preferred embodiments, the microporous membrane is a dry process microporous membrane. As understood in the art, a dry process membrane is a membrane made without the use of solvents or oils. As understood in the art, scanning electron micrographs (SEMs) of dry process membranes look distinctly different than those of wet process membranes, which are made using solvents and oils. See P. Arora and Z. Zhang, Battery Separators, Chem. Rev. 2004, 104, 4419-4462.

In some preferred embodiments, the microporous membrane may be formed using a cast or bubble extrusion process.

The microporous membranes described herein may have an average pore size of 1 micron or less, 0.9 microns or less, 0.8 microns or less, 0.7 microns or less, 0.6 microns or less, 0.5 microns or less, 0.4 microns or less, or 0.35 microns or less.

The composition of the microporous membrane is not so limited, but the microporous membranes described herein preferably comprise, consist of, or consist essentially of one or more polypropylenes. In some preferred embodiments, the microporous membranes described herein comprise, consist of, or consist essentially of polypropylene homo-polymers or co-polymers. In some embodiments, the microporous membrane or at least its outer surface, layer or ply may comprise, consist of, or consist essentially of both long branch chain polypropylene and linear polypropylene (homo-polymers, co-polymers, etc.) Preferably, the melt temperature of the microporous membrane is >160° C. or >165° C. The melt temperature of the membrane is dependent, at least in part, of the composition of the film or its layers.

In some possibly preferred embodiments, the microporous membrane may exhibit one or more, two or more, three or more, four or more, five or more, or all of the following properties: (1) a puncture strength of 130 gf or more; (2) an MD tensile strength above 1,000 kg/cm²; (3) an increased surface roughness; (4) an average pore size of at least 0.20 microns; (5) an increased DB; (6) a TD tensile strength above 50 kg/cm²; (7) a lower ply to ply adhesion force; (8) a polypropylene blend including up to 50% by weight long chain branched polypropylene; (9) a reduced surface area; and/or (10) a thickness of less than 30 microns.

In yet another aspect, object or embodiment, a battery separator for use in energy storage devices such as primary batteries, secondary batteries, or fuel cells may comprise at least one microporous membrane. The microporous membrane may be a microporous membrane, separator membrane, battery separator, or base film comprising a microporous membrane, wherein the microporous membrane has a thickness from 1 microns to 50 microns, 2 microns to 25 microns, 4 microns to 12 microns, or 5 microns to 10 microns, and exhibits one or more, two or more, three or more, four or more, five or more, or all of the following properties: (1) a puncture strength of 130 gf or more; (2) an MD tensile strength above 1,000 kg/cm²; (3) an increased surface roughness; (4) an average pore size of at least 0.20 microns; (5) an increased DB; (6) a TD tensile strength above 50 kg/cm²; (7) a lower ply to ply adhesion force; (8) a polypropylene blend including up to 50% by weight long chain branched polypropylene; (9) a reduced surface area; and/or (10) a thickness of less than 30 microns.

The microporous membrane, separator membrane, battery separator, or base film above, wherein the microporous membrane has an MD tensile strength above 1,000 kg/cm², above 1,320 kg/cm², or above 1,340 kg/cm².

The microporous membrane, separator membrane, battery separator, or base film above, wherein the microporous membrane has a porosity above 20% or above 25%.

The microporous membrane, separator membrane, battery separator, or base film above, wherein the microporous membrane is a dry process polyolefin membrane and has a thickness from 5 microns to 10 microns; a puncture strength of 130 gf or more; an MD tensile strength above 1,000 kg/cm²; an increased surface roughness; an average pore size of at least 0.20 microns; an increased DB; a TD tensile strength above 50 kg/cm²; a lower ply to ply adhesion force; a polypropylene blend including up to 50% by weight long chain branched polypropylene; a reduced surface area; and/or a porosity at or above 20%.

The microporous membrane, separator membrane, battery separator, or base film above, wherein the microporous membrane has one or more layers or plies.

The microporous membrane, separator membrane, battery separator, or base film above, wherein the microporous membrane has at least one outer surface, layer or ply made of a polypropylene blend including up to 50% by weight long chain branched polypropylene.

The microporous membrane, separator membrane, battery separator, or base film above, wherein the microporous membrane is a dry-process microporous membrane.

The microporous membrane, separator membrane, battery separator, or base film above, wherein the microporous membrane has a melt point above 160° C.

The microporous membrane, separator membrane, battery separator, or base film above, wherein the microporous membrane is coated on one or two sides thereof.

An energy storage device comprising the microporous membrane, separator membrane, battery separator, or base film above, wherein the energy storage device is a primary battery, a secondary battery, or a fuel cell.

In still yet another aspect, object or embodiment, a dry process polyolefin microporous membrane has a thickness from 3 microns to 30 microns, and exhibits one or more of the properties: (1) a puncture strength of 130 gf or more; (2) an MD tensile strength above 1,000 kg/cm²; (3) an increased surface roughness; (4) an average pore size of at least 0.35 microns; (5) an increased DB; (6) a TD tensile strength above 50 kg/cm²; (7) a lower ply to ply adhesion force; (8) a polypropylene blend including up to 50% by weight long chain branched polypropylene; (9) a reduced surface area; and/or (10) a porosity of at least 20%.

In a further aspect, object or embodiment, a dry process polypropylene microporous membrane has a thickness from 3 microns to 30 microns, and exhibits one or more of the properties: (1) a puncture strength of 130 gf or more; (2) an MD tensile strength above 1,000 kg/cm²; (3) an increased surface roughness; (4) an average pore size of at least 0.20 microns; (5) an increased DB; (6) a TD tensile strength above 50 kg/cm²; (7) a lower ply to ply adhesion force; (8) a polypropylene blend including up to 50% by weight long chain branched polypropylene; (9) a reduced surface area; and/or (10) a porosity of at least 20%.

Another possibly preferred improved microporous membrane is described herein. The microporous membrane may be useful as a battery separator, separator membrane, base film, or membrane with a variety of uses thereof. The improved microporous membranes described herein may be dry process polyolefin membranes and may be used as battery separators or as a component of a composite or battery separator. The battery separators or composites may be used in energy storage devices including primary batteries, secondary batteries, fuel cells, capacitors, or super capacitors.

In some embodiments, the puncture strength of the above microporous membrane may be 230 gf or more, 240 gf or more, 250 gf or more, 260 gf or more, 270 gf or more, or 290 gf or more.

In some embodiments, the microporous membrane may have an MD tensile strength above 1,000 kg/cm², above 1,100 kg/cm², above 1,200 kg/cm², above 1,300 kg/cm², or above 1,340 kg/cm².

In some embodiments, the microporous membrane is a dry-process microporous membrane.

In some embodiments, the microporous membrane is a microporous membrane having a melting point above 165° C.

In some embodiments, the microporous membrane is coated on one or two sides thereof.

In another aspect, an energy storage device comprising the battery separator described above wherein the energy storage device may be a primary battery, a secondary battery, a fuel cell, a capacitor, or a super capacitor.

In possibly preferred embodiments, the microporous membrane exhibits a puncture strength of 130 gf or more.

### Battery Separator

In some embodiments, a battery separator may comprise, consist of, or consist essentially of a microporous membrane as described herein. In some embodiments, the battery separator may comprise, consist of, or consist essentially of a microporous membrane as described herein and at least one other microporous membrane.

In some embodiments, one or two sides of the microporous membrane may be coated. The coatings may be continuous or discontinuous. The coating may have a thickness from 0.5 to 5 microns, from 0.5 to 4 microns, from 0.5 to 3 microns, from 0.5 to 2 microns, or from 0.5 to 1 micron. For two-side coated embodiments, the coatings on each side may be the same or different.

The coating is not so limited and may be a ceramic coating, a sticky or adhesive coating, a shutdown coating, or the like. In some embodiments, the coating may comprise two or more layers. For example, the coating may comprise a ceramic layer with an adhesive layer provided on top of the ceramic layer. The adhesive layer may be continuous or discontinuous.

### Energy Storage Device

An energy storage device that comprises, consists of, or consists essentially of a battery separator as described herein is disclosed. The energy storage device may be a primary battery, a secondary battery, a fuel cell, a capacitor, or a super capacitor. Examples of secondary batteries may include Li-ion batteries, Na-ion batteries, flow batteries, and the like.

These energy storage devices may be used in electric vehicles (EVs), battery electric vehicles (BEVs), hybrid electric vehicles (HEVs), or plug-in hybrid electric vehicles (PHEVs).

### EXAMPLES

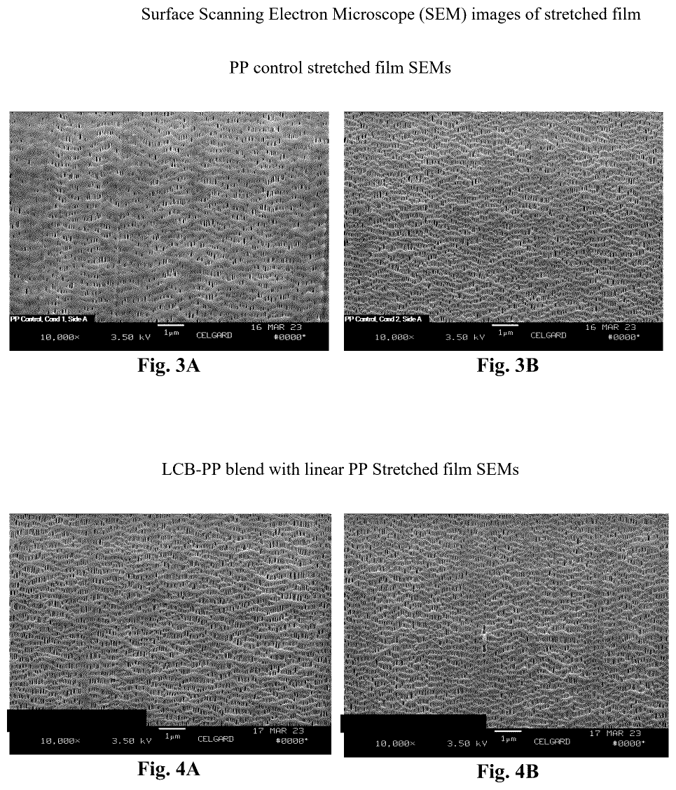

FIG. 3A and FIG. 3B are SEM images of the surface of a typical PP microporous membrane. FIG. 4A and FIG. 4B are SEM images of the surface of an inventive LCB-PP with linear PP (such as a blend of less than 10% by weight long chain branching PP (LCB-PP) with linear PP. In plastic film manufacturing process, multiple layers of thin film layers are packed together tightly during winding operations or other types of handling. The high ply-to-ply adhesion of adjacent film layers also called “blocking” is a potential problem encountered. The problem is more severe in separators made of polypropylene (PP). To solve the “blocking” issue, commercial anti-blocking agents are widely used in plastic film manufacturing process. These commercial anti-block agents can be divided two categories, inorganic particles such as silica, calcium carbonate, etc. which protruding from the film surface to decrease the contact areas thus reducing the overall frictions and organics such as amides, stearates, silicones, etc. that migrate to the film surface and add lubricity to the surface.

However, neither of these two types of anti-blocking agents may meet the higher electrochemical stability requirement in Lithium-Ion battery and may limit use of these commercial anti-blocking agents in Lithium-Ion battery separators. In one aspect or invention, a type of polypropylene resin with long chain branching (LCB-PP) is used to increase surface roughness of the PP separator thus to reduce the ply-to-ply adhesion. Different than commercial anti-block agents, long chain branching PP is a type of PP resin which has great electrochemical stability thus will not affect battery performance. It is believed that long chain branching PP resin of at least 1%, less than 5%, or less than 10% by weight may increase film surface roughness.

Our experimental results show that by blending long chain branching PP into regular linear PP significantly increased the surface roughness. Higher surface roughness could also help reduce COF or to lower Pin removal force for PP separators used in cylindrical batteries.

### Thermal Property Comparison:

Film with 1% to 5% Long chain branch PP resin may show slightly higher melt point and similar crystallinity. Sample with 1% to 5% Long chain branch PP may crystalize at much higher temp, and may show 1 to 10 deg C. difference in crystallization temp.

We extruded mono PP film with 0% and with about 1% to 10% Long chain branch PP.

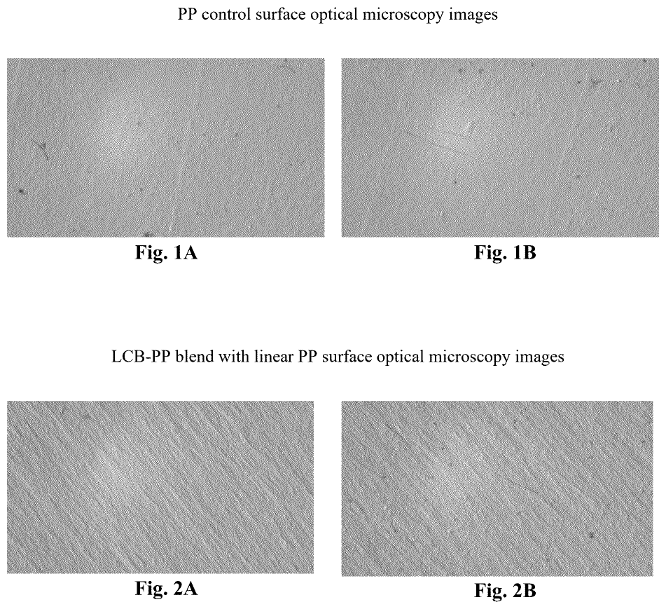

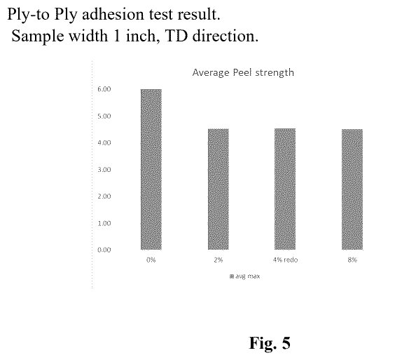

a. Optical Microscope Images of Annealed Film.
Sample with LCB-PP (FIG. 2A and FIG. 2B) showed higher surface roughness than control stretched film sample (FIG. 1A and FIG. 1B) which is 100% regular linear PP.
   Samples with long chain branch (FIG. 4A and FIG. 4B) showed more uniform pore size distribution than the control sample (FIG. 3A and FIG. 3B) especially at lower stretch ratios.
FIG. 5 shows comparison Ply-to Ply adhesion test result.
Sample width 1 inch, TD direction.

### Pore Size

Pore size and porosity with long chain branch PP is slightly bigger.

### Dielectric Breakdown (DB)

DB for stretched film with long chain branch PP is slightly higher.

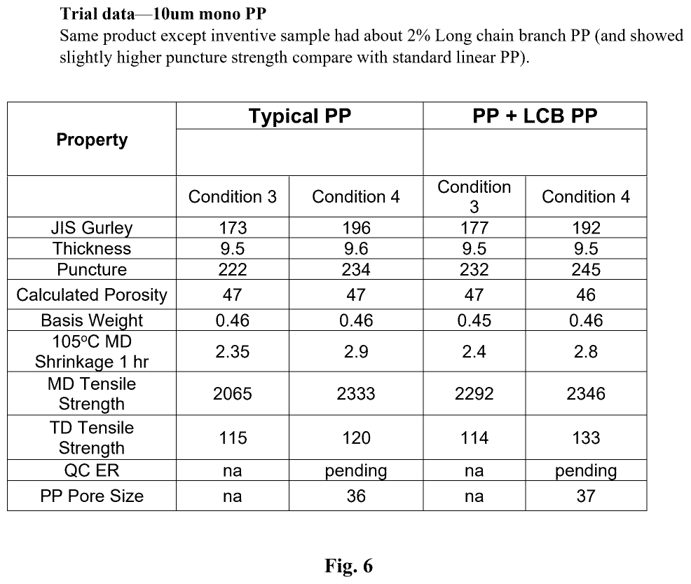

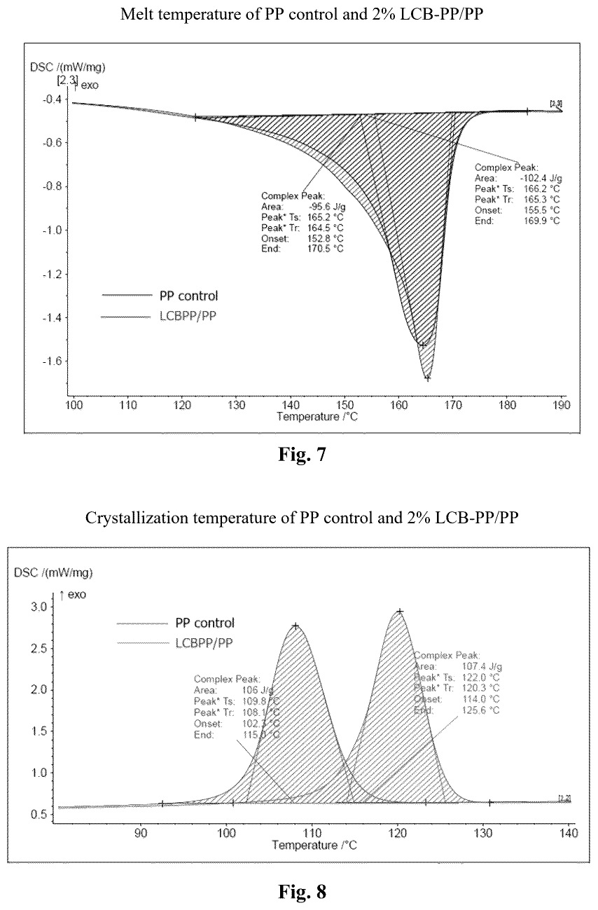

### FIG. 6 Shows the Following Trial Data—10 Um Mono PP

Same PP product except inventive sample had about 2% Long chain branch PP (and showed slightly higher puncture strength compare with standard linear PP).

| | Typical PP | | PP + LCB PP | |
|---|---|---|---|---|
| | Condition | Condition | Condition | Condition |
| Property | 3 | 4 | 3 | 4 |
| JIS Gurley | 173 | 196 | 177 | 192 |
| Thickness | 9.5 | 9.6 | 9.5 | 9.5 |
| Puncture | 222 | 234 | 232 | 245 |
| Calculated Porosity | 47 | 47 | 47 | 46 |
| Basis Weight | 0.46 | 0.46 | 0.45 | 0.46 |
| 105° C. MD Shrinkage | 2.35 | 2.9 | 2.4 | 2.8 |
| 1 hr | | | | |
| MD Tensile Strength | 2065 | 2333 | 2292 | 2346 |
| TD Tensile Strength | 115 | 120 | 114 | 133 |
| QC ER | na | pending | na | pending |
| PP Pore Size | na | 36 | na | 37 |

However, neither of these two types of anti-blocking agents may meet the higher electrochemical stability requirement in Lithium-Ion battery and may limit use of these commercial anti-blocking agents in Lithium-Ion battery separators. In one aspect or invention, a type of polypropylene resin with long chain branching (LCB-PP) is used to increase surface roughness of the PP separator thus to reduce the ply-to-ply adhesion. Different than commercial anti-block agents, long chain branching PP is a type of PP resin which has great electrochemical stability thus will not affect battery performance. It is believed that long chain branching PP resin of at least 1%, less than 10%, or less than 20% by weight may increase film surface roughness.

Our experimental results show that by blending long chain branching PP into regular linear PP significantly increased the surface roughness. Higher surface roughness could also help reduce COF or to lower Pin removal force for PP separators used in cylindrical batteries.

### Thermal Property Comparison:

Film with 1% to 5% Long chain branch PP resin may show similar melt point and crystallinity. Sample with 1% to 5% Long chain branch PP may crystalize at much higher temperature and may show 1 to 10 deg C. difference in crystallization temperature. See FIGS. 7 and 8.

We extruded mono PP film with 0% and with about 1% to 10% Long chain branch PP.

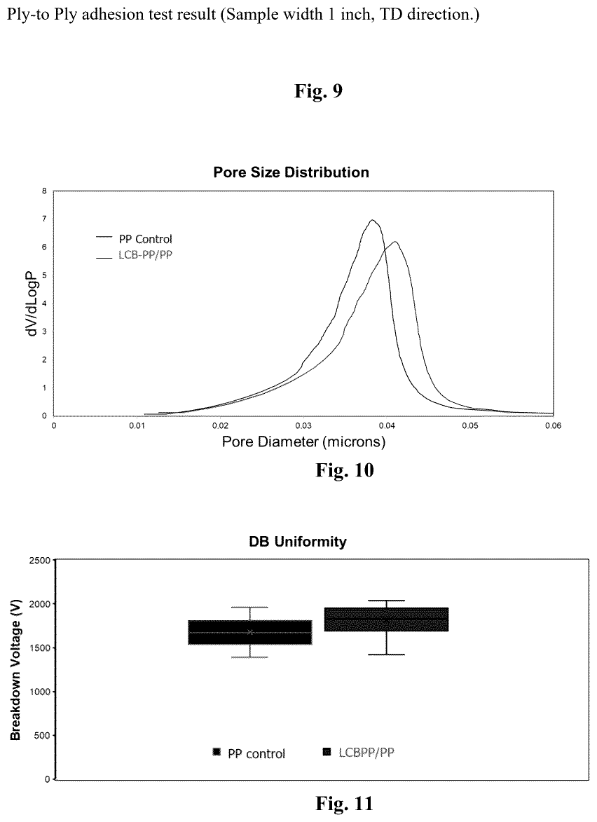

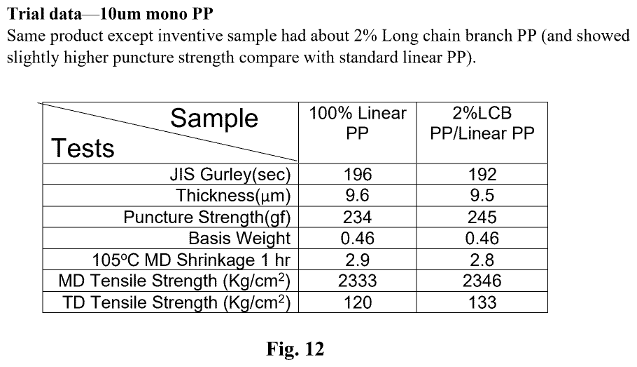

a. Optical Microscope Images of Annealed Film.
Sample with LCB-PP show higher surface roughness than control sample which is 100% regular linear PP. See FIGS. 1A, 1B, 2A, and 2B.
   Surface SEMs of stretched films. See FIGS. 3A, 3B, 4A, and 4B.
Ply-to Ply adhesion test result FIG. 9.
   Sample width 1 inch, sample is cut along transverse direction.
Pore size FIG. 10.
   Pore size and porosity with long chain branch PP is slightly bigger. Sample with long chain branch show more uniform pore size distribution especially at lower stretch ratios. See FIG. 10.
   DB for stretched film with long chain branch PP is slightly higher. See FIG. 11.
FIG. 12 shows Trial data—10 μm mono PP samples:
Same PP product except inventive sample had about 2% Long chain branch PP (and showed slightly higher puncture strength compare with standard linear PP).

| | Sample | |
|---|---|---|
| | | 2% LCB PP/ |
| Tests | 100% Linear PP | Linear PP |
| JIS Gurley(sec) | 196 | 192 |
| Thickness(μm) | 9.6 | 9.5 |
| Puncture Strength(gf) | 234 | 245 |
| Basis Weight | 0.46 | 0.46 |
| 105° C. MD Shrinkage 1 hr | 2.9 | 2.8 |
| MD Tensile Strength (Kg/cm²) | 2333 | 2346 |
| TD Tensile Strength (Kg/cm²) | 120 | 133 |

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and sub-combinations and are contemplated within the scope of the claims.

1. A microporous membrane, separator membrane, battery separator, or base film comprising a microporous membrane,
wherein the microporous membrane has a thickness from 1 microns to 50 microns, 2 microns to 25 microns, 4 microns to 12 microns, or 5 microns to 10 microns, and exhibits one or more, two or more, three or more, four or more, five or more, or all of the following properties: (1) a puncture strength of 230 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 10% by weight long chain branched polypropylene; (9) a reduced surface area; and/or (10) a thickness of less than 12 microns.

2. The microporous membrane, separator membrane, battery separator, or base film of claim 1, wherein the microporous membrane has an MD tensile strength above 2,300 kg/cm², above 2,320 kg/cm², or above 2,340 kg/cm².

3. The microporous membrane, separator membrane, battery separator, or base film of claim 1, wherein the microporous membrane has a porosity above 40% or above 45%.

4. The microporous membrane, separator membrane, battery separator, or base film of claim 1, wherein the microporous membrane is a dry process polyolefin membrane and has a thickness from 5 microns to 10 microns; a puncture strength of 230 gf or more; an MD tensile strength above 2,200 kg/cm²; an increased surface roughness; an average pore size of at least 0.40 microns; an increased DB; a TD tensile strength above 130 kg/cm²; a lower ply to ply adhesion force; a polypropylene blend including up to 5% by weight long chain branched polypropylene; a reduced surface area; and/or a porosity at or above 45%.

5. The microporous membrane, separator membrane, battery separator, or base film of claim 1, wherein the microporous membrane has one or more layers or plies.

6. The microporous membrane, separator membrane, battery separator, or base film of claim 1, wherein the microporous membrane has at least one outer surface, layer or ply made of a polypropylene blend including up to 5% by weight long chain branched polypropylene.

7. The microporous membrane, separator membrane, battery separator, or base film of claim 1, wherein the microporous membrane is a dry-process microporous membrane.

8. The microporous membrane, separator membrane, battery separator, or base film of claim 1, wherein the microporous membrane has a melt point above 165° C.

9. The microporous membrane, separator membrane, battery separator, or base film of claim 1, wherein the microporous membrane is coated on one or two sides thereof.

10. An energy storage device comprising the microporous membrane, separator membrane, battery separator, or base film of claim 1, wherein the energy storage device is a primary battery, a secondary battery, or a fuel cell.

11. A dry process polyolefin microporous membrane having a thickness from 4 microns to 12 microns, and exhibiting one or more of the properties: (1) a puncture strength of 230 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 10% by weight long chain branched polypropylene; (9) a reduced surface area; and/or (10) a porosity of at least 45%.

12. A dry process polypropylene microporous membrane having a thickness from 4 microns to 12 microns, and exhibiting two or more of the properties: (1) a puncture strength of 230 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 10% by weight long chain branched polypropylene; (9) a reduced surface area; and/or (10) a porosity of at least 45%.

13. A microporous membrane, separator membrane, battery separator, or base film comprising a microporous membrane,
wherein the microporous membrane has a thickness from 1 microns to 50 microns, 2 microns to 25 microns, 4 microns to 12 microns, or 5 microns to 10 microns, and exhibits one or more, two or more, three or more, four or more, five or more, or all of the following properties: (1) a puncture strength of 130 gf or more; (2) an MD tensile strength above 1,000 kg/cm²; (3) an increased surface roughness; (4) an average pore size of at least 0.20 microns; (5) an increased DB; (6) a TD tensile strength above 50 kg/cm²; (7) a lower ply to ply adhesion force; (8) a polypropylene blend including up to 50% by weight long chain branched polypropylene; (9) a reduced surface area; and/or (10) a thickness of less than 32 microns.

14. The microporous membrane, separator membrane, battery separator, or base film of claim 13, wherein the microporous membrane has an MD tensile strength above 1,300 kg/cm², above 1,320 kg/cm², or above 1,340 kg/cm².

15. The microporous membrane, separator membrane, battery separator, or base film of claim 13, wherein the microporous membrane has a porosity above 30% or above 35%.

16. The microporous membrane, separator membrane, battery separator, or base film of claim 13, wherein the microporous membrane is a dry process polyolefin membrane and has a thickness from 5 microns to 10 microns; a puncture strength of 130 gf or more; an MD tensile strength above 1,000 kg/cm²; an increased surface roughness; an average pore size of at least 0.20 microns; an increased DB; a TD tensile strength above 50 kg/cm²; a lower ply to ply adhesion force; a polypropylene blend including up to 5% by weight long chain branched polypropylene; a reduced surface area; and/or a porosity at or above 25%.

17. The microporous membrane, separator membrane, battery separator, or base film of claim 13, wherein the microporous membrane has one or more layers or plies.

18. The microporous membrane, separator membrane, battery separator, or base film of claim 13, wherein the microporous membrane has at least one outer surface, layer or ply made of a polypropylene blend including up to 50% by weight long chain branched polypropylene; wherein the microporous membrane is a dry-process stretched microporous membrane; wherein the microporous membrane has a melt point above 160° C.; or wherein the microporous membrane is coated on one or two sides thereof.

19. An energy storage device comprising the microporous membrane, separator membrane, battery separator, or base film of claim 13, wherein the energy storage device is a primary battery, a secondary battery, or a fuel cell.

20. A dry process polyolefin microporous membrane having a thickness from 3 microns to 32 microns, and exhibiting one or more of the properties: (1) a puncture strength of 130 gf or more; (2) an MD tensile strength above 1,000 kg/cm²; (3) an increased surface roughness; (4) an average pore size of at least 0.25 microns; (5) an increased DB; (6) a TD tensile strength above 50 kg/cm²; (7) a lower ply to ply adhesion force; (8) a polypropylene blend including up to 50% by weight long chain branched polypropylene; (9) a reduced surface area; and/or (10) a porosity of at least 25%.
